(19) United States
(12) Patent Application Publication
(10) Pub. No.: US 2016/0188510 A1
(43) Pub. Date: Jun. 30, 2016

(54) METHOD FETCHING/PROCESSING NVMe COMMANDS IN MULTI-PORT, SR-IOV OR MR-IOV SUPPORTED PCIe BASED STORAGE DEVICES

(71) Applicant: SAMSUNG ELECTRONICS CO., LTD., SUWON-SI (KR)

(72) Inventors: SANTOSH SINGH, BANGALORE (IN); VIKRAM SINGH, BANGALORE (IN)

(21) Appl. No.: 14/968,355

(22) Filed: Dec. 14, 2015

(30) Foreign Application Priority Data
Dec. 26, 2014 (IN) 6621/CHE/2014

(51) Int. Cl. G06F 13/362; G06F 13/42; G06F 13/40

(52) U.S. Cl. CPC G06F 13/362; G06F 13/4068; G06F 13/4282

(57) ABSTRACT

A method of fetching I/O commands received from a host in a Peripheral Component Interconnect Express (PCIe) device includes; assigning priority to PCIe functions in the host, fetching a PCIe function from among the PCIe functions based on an assigned priority, selecting a host command queue associated with the selected PCIe function, and indicating the selected host command queue, as well as a number of commands to be fetched from the selected command queue.

### RELATED APPLICATION(S)

This U.S. Patent application claims the benefit under 35 U.S.C. §119 of Indian Application No. 6621/CHE/2014 filed on Dec. 26 2014, the subject matter of which is hereby incorporated by reference.

### BACKGROUND

Embodiments of the inventive concept relate generally to Peripheral Component Interconnect Express (PCIe) based storage devices, and more particularly, to methods of assigning the priority to various PCIe functions where host commands are fetched and processed according to an assigned priority.

PCIe based storage devices provide exceptional data storage capacity, excellent data processing speed and have proven to be highly scalable. As a result, storage device manufacturers are now able to provide multi-Terra Byte sized storage devices. Contemporaneously, there is a rising demand for standard based PCIe storage virtualization solutions which include storage devices that support Single Root (SR) Input Output Virtualization (IOV) and Multiple Root (MR) IOV, hereafter respectively indicated as SR-IOV and MR-IOV.

However, as yet, few storage device are commercially available that support SR-IOV and/or MR-IOV. Rather, current storage devices support PCI virtualization as per specifications defined by the PCI Special Interest Group (PCI-SIG). Of note, in PCIe based virtualized devices, there is no mechanism to assign respective priorities of various PCIe functions (e.g., Virtual Function (VF) and/or Physical Function (PF)).

As a result, there is a need for an efficient and priority-based approach to fetching and processing commands in SR-IOV or MR-IOV supported storage devices. In enterprise storage environments, it is highly likely that some PCIe functions may need to be accessed according to a priority basis.

### SUMMARY

Embodiments of the inventive concept provide methods of assigning priority to PCIe functions in PCIe based storage devices, such as Non-Volatile Memory (NVM) express (NVMe) storage devices. Embodiments of the inventive concept also provide methods of fetching and processing commands in SR-IOV or MR-IOV supported storage devices according to assigned PCIe function priorities. In these regards and others, embodiments of the inventive concept provide an efficient, priority-based methods and devices that fetch/process input/output (I/O protocol commands in various PCIe based storage devices (e.g., NVMe) characterized by multi-port data access, SR-IOV, and/or MR-IOV.

One aspect of the inventive concept provides a method fetching input/output (I/O) commands received from a host in a Peripheral Component Interconnect Express (PCIe) device. The method includes; assigning priority to PCIe functions in the host, fetching a PCIe function from among the PCIe functions based on an assigned priority, selecting a host command queue associated with the selected PCIe function, and indicating the selected host command queue, as well as a number of commands to be fetched from the selected command queue.

Another aspect of the inventive concept provides a Peripheral Component Interconnect Express (PCIe) system including a storage device connected to a host via a PCIe connection. The method includes recognizing a priority assigned by the host for each one of a plurality of PCIe functions, wherein the host selects a port amongst available ports of the storage device, selects a PCIe function from amongst the plurality of PCIe functions, and selects a commands associated with the selected PCIe function, and executing the selected commands according to a sequence in accordance with the priority of the selected PCIe function and a priority assigned to the selected PCIe function.

Another aspect of the inventive concept provides a method of operating a Peripheral Component Interconnect Express (PCIe) system comprising a storage device including multiple ports connected to a host via a PCIe connection. The method includes; using an arbitration module of the host, selecting a port from amongst the multiple ports of the storage device, and selecting a PCIe function from amongst a plurality of PCIe functions according to an assigned priority for the selected PCIe function, processing the selected PCIe function via the selected port.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of embodiment and the accompanying drawings in which:

FIG. 1 is a conceptual diagram illustrating exemplary and comparative arbitration and command fetching associated with PCIe functions.

FIG. 2 is a block diagram illustrating a single host/device connection according to an embodiment of the inventive concept.

FIG. 3 is a block diagram illustrating a host subsystem according to an embodiment of the inventive concept.

FIG. 4 is a conceptual diagram illustrating exemplary arbitration and command fetching associated with PCIe functions according to an embodiment of the inventive concept.

FIG. 5 is a flowchart summarizing a method enabling arbitration and command fetching by a PCIe device according to an embodiment of the inventive concept.

Although specific features of the inventive concept are shown in certain drawings and not in others, this is done for convenience only as each feature may be combined with any or all of the other features in accordance with the inventive concept.

### DETAILED DESCRIPTION

In various embodiments, the inventive concept provides priority-based methods for fetching and processing I/O protocol commands in PCIe based storage devices (e.g., NVMe) characterized by multi-port data access, SR-IOV and/or MR-IOV. In the following detailed description of embodiments, reference is made to the accompanying drawings. These embodiments are described in sufficient detail to enable those skilled in the art to practice the inventive concept, and it is to be understood that other embodiments may be utilized and that changes may be made without departing from the scope of the inventive concept. The following detailed description is, therefore, to be taken not in a limiting sense, but rather the scope of the inventive concept is defined by the appended claims.

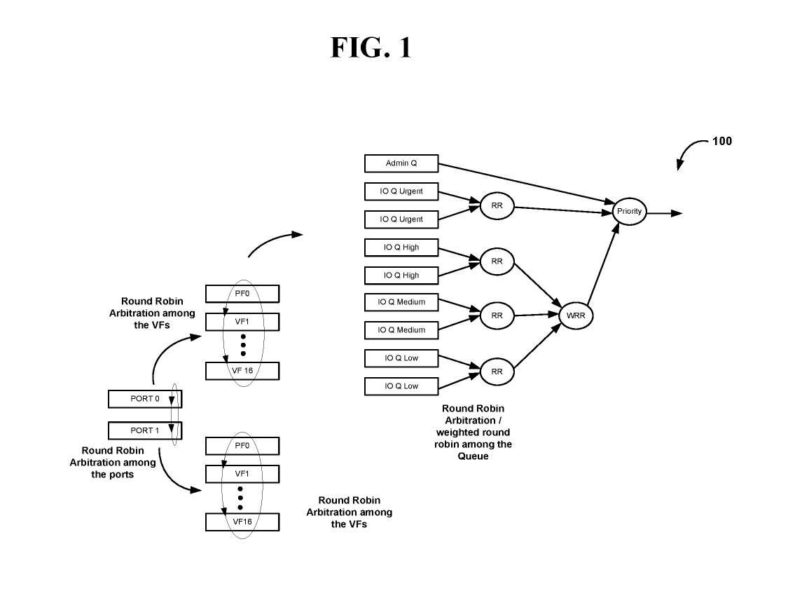

Figure (FIG. 1 is a conceptual diagram illustrating for comparative purposes certain conventional arbitration and command fetching processes associated with PCIe functions. Conventional PCIe based SR-IOV and MR-IOV specifications do not assign priority to PCIe functions, such as PFs and/or VFs. Rather, the PFs and VFs conventionally associated with PCIe devices are assumed to have the same priority, although they may have different task(s) and corresponding permission(s) assigned.

With regard to the conceptual diagram of FIG. 1, conventional storage devices that support PCIe based virtualizations implement method(s) that fetch and process I/O commands from host according to the following approach.

Assuming that a storage device is a multi-port device having multiple ports (e.g., PORT 0 and PORT 1) that operate simultaneously, an arbitration module may be used to selects amongst the available ports using a round robin arbitration. The arbitration module may also be used to arbitrate amongst both PFs and VFs, thereby selecting a corresponding PCIe function, using the round robin arbitration. The arbitration module also arbitrates amongst Inbound/Submission host command IO queues for the selected PCIe function, and selects a queue according to a priority (e.g., Admin Q, Q Urgent, Q High, Q Medium and Q Low) assigned by a round robin (RR) arbitration and/or weighted RR arbitration, as assigned by a host.

Thus, the arbitration module may be used to monitor commands received from one or more hosts by checking, for example, a producer index/tail doorbell of the Inbound/Submission host command queue that indicates a selected queue along with a number of commands to be fetched from the host to a command fetch module. Once the command(s) are fetched, they may be sent to various command processing modules of the constituent device. Then, the commands may be processed in the sequence received from command fetch module.

This general approach continues so long as functions and commands are applied to the device. Yet, in this conventional approach the device does not know a priority for any of the PCIe functions (e.g., PFs and/or VFs) when the SR-IOV is enabled.

As compared with the conventional approach, various embodiments of the inventive concept provide improved Quality of Service (QoS) for NVMe devices and other PCIe based host controller specification based storage devices. In this regard, QoS has become an important design consideration in contemporary devices. Some services require high QoS, while others require less stringent QoS. Accordingly, it is important that any given device be able to recognize relative QoS requirements, and be able to process services according to a rationally ascribed QoS-based (at least in part) priority. Hence, embodiments of the inventive concept provide methods of effectively assigning respective priorities for PCIe functions (e.g., PFs and/or VFs) and ports, and corresponding methods for fetching and processing commands according to the priorities assigned by the host environment. In this regard, an assignment of port of PCIe function priority may be made using a side-band management protocol, or user-specific command associated with an I/O protocol.

As will be appreciated by those skilled in the art, a PF is a PCIe function associated with a storage device that supports a SR-IOV or MR-IOV interface. For example, a PF may include a SR-IOV extended capability in the PCIe configuration space. This capability may be used to configure and manage the SR-IOV functionality of the storage device such as enabling virtualization and exposing one or more VFs. In contrast, a VF is a lightweight PCIe function associate with the storage device that supports a SR-IOV or MR-IOV interface. A VF may be associated with one or more PF of the storage device, and represents a virtualized instance of the storage device. Each VF may have its own PCI configuration space, and may shares one or more physical resources of the storage device.

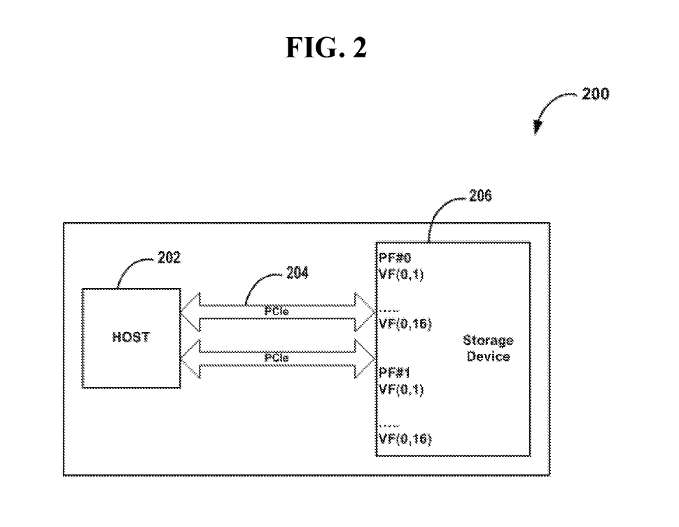

FIG. 2 is a block diagram illustrating a single host/device connection 200 via one or more PCIe connections. Here, the a host 202 establishes one or more PCIe connection(s) 204 with a corresponding PCIe Port of the storage device 206. Consistent with embodiments of the inventive concept, priority is assigned to the PCIe functions (e.g., PF#0, including VF (0,1) through VF (0,16) and PF#1, including VF (0,1) through VF (0,16)) as well as the PCIe ports. After assigning priority to the PCIe functions and PCIe ports, host-generated commands are fetched and processed according to their assigned priority. As noted above, priority assignment may be done via one or more side band management protocols, or using a vendor-specific command that is part of a normal I/O protocol.

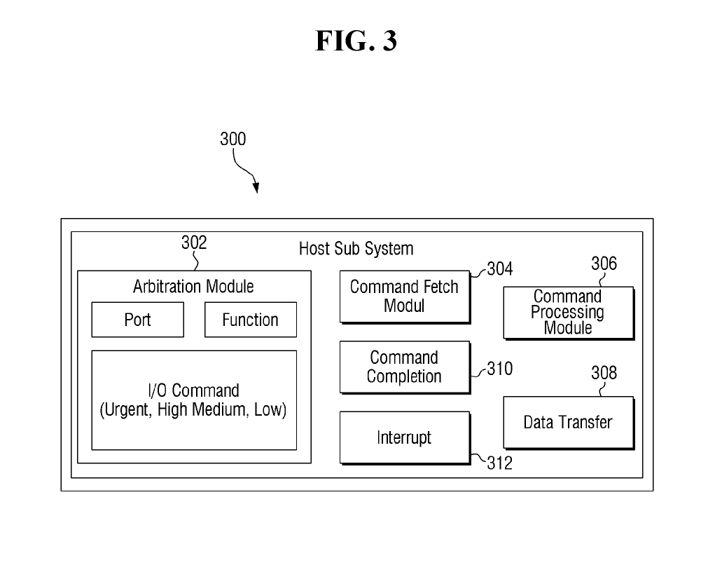

FIG. 3 is a block diagram illustrating a host subsystem 300 according to an embodiment of the inventive concept. The host subsystem 300 includes an arbitration module 302 that arbitrates to select a host command queue of the selected PCIe function, indicates the selected host command queue, and also indicates a number of commands to be fetched from the selected host command queue to a command fetch module 304. After command fetching, the commands are sent to the command processing module 306 for processing. Here, the commands are processed in not only in view of the received sequence from the command fetch module 304, but also in view of corresponding, assigned (and descending) priorities associated with Port, then Function, and then Host Command Queue. Of course this assumption of related priorities is just one example, and embodiments of the inventive concept may make use of many different priority definitions. Any given hierarchy of priorities may, however, be interrupted in its execution sequence upon indication by an interrupt unit. Accordingly, superior subsystem events (e.g., an unexpected power interruption) may override a prioritized sequence of commands.

Once one or more commands is processed via the command processing module, possibly using a data transfer unit 308, and command completion indication may be generated and/or stored in a command completion unit 310.

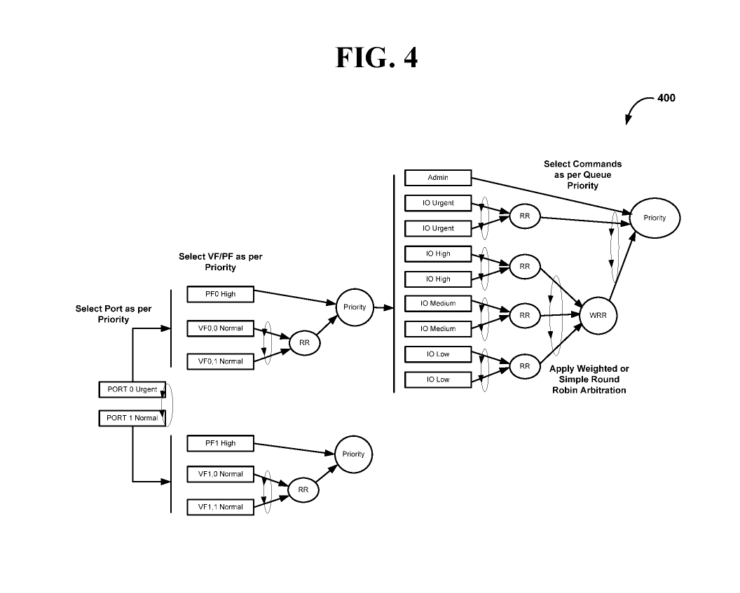

FIG. 4 is another conceptual diagram illustrating arbitration and command fetching and processing of PCIe functions according to an embodiment of the inventive concept. Here, the conceptually illustrated embodiments provides a method of assigning priority to various PCIe functions in a multi-port, multi-function PCIe device. Priority assignment is assumed to be accomplished using one or more side band management protocols or vendor-specific command that is part of a normal I/O protocol. After the assigning of priority to PCIe functions, an exemplary method of fetching and processing host commands according to assigned priority may us the following approach.

With reference to FIGS. 3 and 4, and again assuming that a storage device is a multi-port device having one or more ports that is capable of operating simultaneously, the arbitration module 302 selects ports according to an assigned priority. The arbitration module 302 arbitrates among the PFs, as well as corresponding VFs, associated with a selected port and then selects the PCIe function according to an assigned priority. The arbitration module 302 then arbitrates among the Inbound/Submission host command queues of the selected PCIe function and selects a queue according to an assigned priority (e.g., per a round robin arbitration) established by a host. The arbitration module 302 monitors command(s) received from one or more host(s) by (e.g.,) checking a producer index/tail doorbell of the Inbound/Submission host command queue, and then indicates the selected queue along with a number of command(s) to be fetched from the host to the command fetch module. Once the commands are fetched, they are sent to the command processing module 306. The commands are then processed in view of their received sequence and their assigned priority (e.g., Port, then Function, and then Host Command Queue).

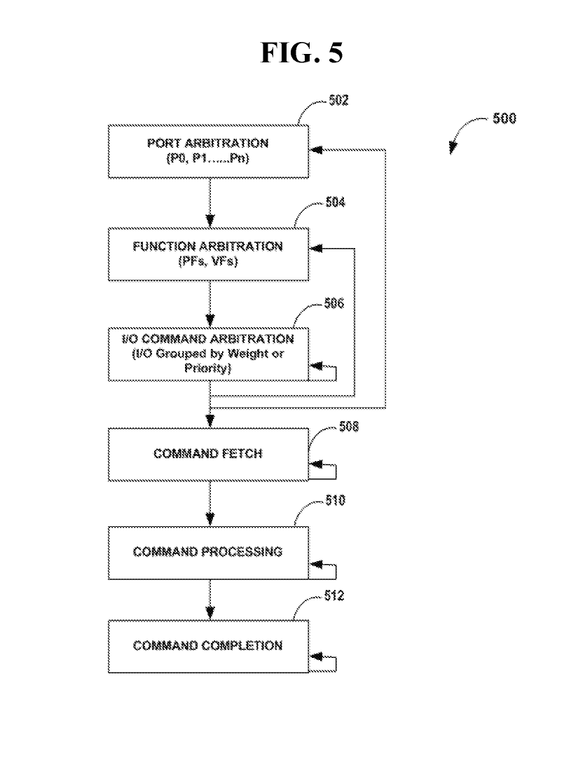

FIG. 5 is a flowchart 500 summarizing in one example an arbitration and command fetching and processing approach that may be used in a PCIe device according to an embodiment of the inventive concept. Here, an arbitration module may be sued to select a port as per assigned priority, thereby performing an available port arbitration (502). The arbitration module may also be used to perform function arbitration, wherein the arbitration module arbitrates among the PFs as well as VFs of selected port, and selects the PCIe function as per priority assigned (504). The arbitration module may also be used to perform a queue arbitration, wherein the arbitration module arbitrates and selects a queue as per the priority assigned or as per round robin arbitration whichever is assigned by host (506). The arbitration module may also be used to perform fetching of commands wherein the arbitration module monitors commands received from the host and indicates the selected queue along with a number of commands to be fetched from the host to the command fetch module (508). The arbitration module in conjunction with a command processing module may be used to process fetched commands (510). Finally, execution of commands is completed using the command completion module and possibly a data transfer unit, wherein the commands are processed in their fetched sequence and according to an assigned priority (512). Here the commands may be ranked according to priorities from highest to lowest of Port, then Function, and then Host Command Queue.

Embodiments of the inventive concept provide a better QoS with respect to one or more hosts by enabling the host to assign respective priority to each PCIe function. In the foregoing written description, the terms “module” and/or “unit” have been used to denote a collection of hardware, firmware and/or software resources as well as various forms of data storing media (e.g., flash memory, Solid State Drive/Disk (SSD), and various distributed memory systems). These resources may be provided by one or more host(s) connected to one or more storage device(s) via one or more PCIe connection(s). Those skilled in the art will recognize that such modules and unit may be variously embodied.

The inventive concept has been described with reference to specific example embodiments. It will be evident that various modifications and changes may be made to the illustrated embodiments without departing from the broader scope of the inventive concept as defined by the following claims.

What is claimed is:

1. A method fetching input/output (I/O) commands received from a host in a Peripheral Component Interconnect Express (PCIe) device, the method comprising:
assigning priority to PCIe functions in the host;
fetching a PCIe function from among the PCIe functions based on an assigned priority;
selecting a host command queue associated with the selected PCIe function; and
indicating the selected host command queue, as well as a number of commands to be fetched from the selected command queue.

2. The method of claim 1, wherein the host comprises an arbitration module, a command fetch module, and a command processing module,
the arbitration module being used to assign the priority to PCIe functions in the host, fetch the PCIe function from among the PCIe functions based on the assigned priority, select the host command queue associated with the selected PCIe function, and indicate the selected host command queue and the number of commands to be fetched from the selected command queue to the command fetch module.

3. The method of claim 2, further comprising:
passing each one of the number of fetched commands from the command fetch module to the command processing module;
assigning priority to the fetched commands; and
processing the each one of the fetched commands based on an assigned priority.

4. The method of claim 3, wherein the number of fetched commands is passed from the command fetch module to the command processing module in a sequence defined by an assigned priority for each one of the fetched commands.

5. The method of claim 1, wherein the assigning of priority to the PCIe functions is based on at least one of; a side band management protocol, a vender specific command associated with an I/O protocol, and a user specific command associated with an I/O protocol.

6. The method of claim 1, wherein each one of PCIe functions is one of a physical function (PF) and a virtual function (VF).

7. The method of claim 2, wherein the arbitration module arbitrates among an inbound host command queue and a submission host command queue associated with the selected PCIe function to select the host command queue for command fetch process.

8. The method of claim 1, wherein the PCIe device is one of a multi-port storage device, a multi-function storage device, and a multi-port and multi-function storage device.

9. A method of operating a Peripheral Component Interconnect Express (PCIe) system including a storage device connected to a host via a PCIe connection, the method comprising:
recognizing a priority assigned by the host for each one of a plurality of PCIe functions, wherein the host selects a port amongst available ports of the storage device, selects a PCIe function from amongst the plurality of PCIe functions, and selects a commands associated with the selected PCIe function; and
executing the selected commands according to a sequence in accordance with the priority of the selected PCIe function and a priority assigned to the selected PCIe function.

10. The method of claim 9, further comprising:
indicating in the host a selected command queue associated with the selected PCIe function together with commands to be fetched from the selected command queue; and
processing the fetched commands according to the sequence.

11. The method of claim 9, wherein the host assigns priority to the available ports of the storage device.

12. The method of claim 9, wherein the assigning of priority to the PCIe functions is based on at least one of a side band management protocol, a vendor specific command associated with an I/O protocol, and a user specific command associated with an I/O protocol.

13. The method of claim 9, the storage device is one of a multi-port storage device, a multi-function storage device, and a multi-port and multi-function storage device.

14. The method of claim 9, wherein the plurality of PCIe functions comprises at least one physical function (PF) and at least one virtual function (VF).

15. A method of operating a Peripheral Component Interconnect Express (PCIe) system comprising a storage device including multiple ports connected to a host via a PCIe connection, the method comprising:
using an arbitration module of the host, selecting a port from amongst the multiple ports of the storage device, and selecting a PCIe function from amongst a plurality of PCIe functions according to an assigned priority for the selected PCIe function; and
processing the selected PCIe function via the selected port.

16. The method of claim 15, wherein the selected PCIe function is associated with a number of commands respectively assigned a priority by the arbitration module, such that the number of commands is executed according to a sequence defined by the priority assigned to the selected PCIe function and a respective priority assigned to the number of commands.

17. The method of claim 16, wherein the selection of the PCIe function is made according to a round robin arbitration.

18. The method of claim 15, wherein the selected PCIe function comprises at least one physical function (PF) and at least one virtual function (VF).

19. The method of claim 15, wherein the assigning of priority to the selected PCIe function is based on at least one of a side band management protocol, a vendor specific command associated with an I/O protocol, and a user specific command associated with an I/O protocol.

20. The method of claim 15, wherein the processing of the selected PCIe function comprises:
indicating a selected command queue associated with the selected PCIe function together with the number of commands to be fetched from the selected command queue;
passing the number of fetched commands to a command processing module, and processing the fetched commands according to the sequence using the command processing module.
